(19) United States
(12) Patent Application Publication
(10) Pub. No.: US 2020/0072607 A1
(43) Pub. Date: Mar. 5, 2020

(54) SENSOR DEVICE AND ELECTRONIC APPARATUS

(71) Applicant: SONY SEMICONDUCTOR SOLUTIONS CORPORATION, KANAGAWA (JP)

(72) Inventors: SATOSHI MITANI, KANAGAWA (JP); HIDETOSHI KABASAWA, KANAGAWA (JP); DAISUKE SAITO, KANAGAWA (JP)

(21) Appl. No.: 16/467,758

(22) PCT Filed: Dec. 20, 2017
(86) PCT No.: PCT/JP2017/045652

§ 371 Date: Jun. 7, 2019

(30) Foreign Application Priority Data
Jan. 11, 2017 (JP) 2017-002797

(51) Int. Cl. G01C 19/5755; G01C 19/5769

(52) U.S. Cl. CPC G01C 19/5755; G01C 19/5769

(57) ABSTRACT

[Object] To reduce an effect of an external stress and to ensure stable detection accuracy. [Solving Means] A sensor device according to an embodiment of the present technology includes a sensor element, a package body, a first buffer, and a second buffer. The sensor element detects input physical quantity. The package body includes a first support and a second support. The first support is electrically connected to the sensor element and supports the sensor element. The second support is electrically connected to the first support and supports the first support. The first buffer is arranged between the sensor element and the first support and elastically connects the sensor element to the first support. The second buffer is arranged between the first support and the second support and elastically connects the first support to the second support.

### TECHNICAL FIELD

The present technology relates to a sensor device including a sensor element that detects physical quantity such as acceleration and an angular velocity, for example, and an electronic apparatus.

### BACKGROUND ART

In recent years, in a technical field of detection of an attitude of an electronic apparatus, detection of a moving body position, camera image stabilization, motion analysis of a human or an object, and the like, a sensor device such as an acceleration sensor and an angular velocity sensor by using a MEMS (Micro Electro Mechanical Systems) technique is widely used. This type of the sensor device includes a sensor element that detects physical quantity such as acceleration and an angular velocity, circuit components that control the sensor element, a package member that supports the sensor element and the circuit components, and the like.

The above-described sensor device is mounted to a circuit substrate built in an electronic apparatus. However, an external stress (thermal stress, bending stress, or the like) applied from the circuit substrate is transmitted to the sensor element via the package member, which may result in a change of an output from the sensor element. Thus, in this type of the sensor device, a stress buffer structure is necessary in order to relax the stress from the circuit substrate and to prevent the change of the output from the sensor element.

For example, Patent Literature 1 discloses a mechanical quantity sensor comprising a semiconductor sensor chip, a circuit chip for supporting the semiconductor sensor chip, and a package case for containing therein the semiconductor sensor chip and the circuit chip, wherein the circuit chip and the package case, and the semiconductor sensor chip and the circuit chip are bonded via an adhesive film, respectively. The above-described Patent Literature 1 describes that the adhesive film relaxes the thermal stress and it can prevent the thermal stress from transmitting to the semiconductor sensor chip.

### CITATION LIST

### Patent Literature

Patent Literature 1: Japanese Patent Application Laid-open No. 2003-270264

### DISCLOSURE OF INVENTION

### Technical Problem

As a functionality of an electronic apparatus gets higher, there is a need to improve a detection accuracy of a sensor device mounted to the electronic apparatus. However, as a performance of the sensor device gets higher in recent years, an impact of an external stress on output properties of the sensor element is getting greater. For this reason, in order to reduce the effect of the external stress and to ensure stable detection accuracy, a development of the sensor device is needed.

The present technology is made in view of the above-mentioned circumstances, and it is an object of the present technology to provide a sensor device and an electronic apparatus such that an effect of an external stress can be reduced and stable detection accuracy can be ensured.

### Solution to Problem

A sensor device according to an embodiment of the present technology includes a sensor element, a package body, a first buffer, and a second buffer.

The sensor element detects input physical quantity.

The package body includes a first support and a second support. The first support is electrically connected to the sensor element and supports the sensor element. The second support is electrically connected to the first support and supports the first support.

The first buffer is arranged between the sensor element and the first support and elastically connects the sensor element to the first support.

The second buffer is arranged between the first support and the second support and elastically connects the first support to the second support.

In the sensor device, the package body is formed of the first support and the second support that are elastically connected via the second buffer and the sensor element is elastically connected to the first support via the first buffer. Thus, an effect of an external stress can be reduced and stable detection accuracy can be ensured.

The first buffer may be formed of a material having an elastic modulus smaller than that of the second buffer. Thus, it is possible to more effectively suppress transmission of the stress to the sensor element.

Alternatively, the first buffer may be formed of a material having an elastic modulus greater than that of the second buffer. Thus, it is possible to relatively stably hold a sensor element that self-excited oscillates.

The second support may have a support surface supporting the first support via the second buffer, a horizontal wall in parallel with the support surface, and a vertical wall perpendicular to the horizontal wall.

Thus, since rigidity of the second support is improved, deformation caused by the stress of the second support can be suppressed.

The vertical wall may be a peripheral wall arranged along a periphery of the horizontal wall.

Alternatively, the support surface may be arranged at one end of the vertical wall, and the second support may further have an external connection terminal arranged at another end of the vertical wall.

Thus, overall rigidity of the vertical wall can be improved.

The sensor device may further include a circuit element enclosed in a space partitioned by the horizontal wall and the vertical wall.

The sensor device may further include a third support and a third buffer. It supports the second support, and the third buffer is arranged between the second support and the third support and elastically connecting the second support to the third support.

The first and second buffers may be formed of a non-limiting material and are formed of any one of an adhesive resin layer, a metal bump, or an anisotropic conductive film, for example.

The first and second supports may be formed of a non-limiting material and are formed of any of ceramics and silicon, for example.

The sensor device may further includes a cap. The cap is attached to the package body and covers the sensor element.

The cap may be attached to the first support or may be attached to the second support.

In the former structure, the first support may have an opening, and the cap may have a weight protruding toward the sensor element via the opening. Thus, since the weight of the first support is increased, the sensor element can be stably supported.

In the latter structure, the first support may be enclosed inside the second support. Thus, it can be avoided that an external force directly acts on the first support.

The sensor element is not especially limited as long as the input physical quantity can be detected. A sensor element that detects an angular velocity, acceleration, a pressure, or the like, an optical element such as a solid-state image sensing device, and

other physical quantity sensors such as an infrared sensor are applicable to the sensor element.

An electronic apparatus according to an embodiment of the present technology includes a sensor device.

The includes a sensor element, a package body, a first buffer, and a second buffer.

The sensor element detects input physical quantity.

The package body includes a first support and a second support. The first support is electrically connected to the sensor element and supports the sensor element. The second support is electrically connected to the first support and supports the first support.

The first buffer is arranged between the sensor element and the first support and elastically connects the sensor element to the first support.

The second buffer is arranged between the first support and the second support and elastically connects the first support to the second support.

### Advantageous Effects of Invention

As described above, according to the present technology, an effect of an external stress can be reduced and stable detection accuracy can be ensured.

It should be noted that the effects described here are not necessarily limitative and may be any of effects described in the present disclosure.

### BRIEF DESCRIPTION OF DRAWINGS

FIG. 1 is a schematic perspective view showing an overall structure of a sensor device according to a first embodiment of the present technology.

FIG. 2 is a schematic sectional side view of the sensor device.

FIG. 3 is a schematic plan view of a first support of the sensor device.

FIG. 4 is a schematic plan view of a second support of the sensor device.

FIG. 5 is a schematic plan view of a sensor element of the sensor device.

FIG. 6 is a sectional view taken along the line [A]-[A] of FIG. 5.

FIG. 7 is a schematic view illustrating the action of the sensor element.

FIG. 8 is a schematic view illustrating the action of the sensor element.

FIG. 9 is a schematic view illustrating the action of the sensor element.

FIG. 10 is a schematic sectional side view showing one modification embodiment of the sensor device.

FIG. 11 is a schematic sectional side view showing other modification embodiment of the sensor device.

FIG. 12 is a schematic perspective view showing a sensor device according to a second embodiment of the present technology.

FIG. 13 is a schematic sectional side view showing one modification embodiment of the sensor device.

FIG. 13 is a schematic sectional side view showing other modification embodiment of the sensor device.

FIG. 15 is a schematic sectional side view showing a sensor device according to a third embodiment of the present technology.

FIG. 16 is other schematic sectional side view showing the sensor device.

FIG. 17 is a schematic sectional side view showing one modification embodiment of the sensor device.

FIG. 18 is a schematic sectional side view showing other modification embodiment of the sensor device.

FIG. 19 is a schematic sectional side view showing a sensor device according to a fourth embodiment of the present technology.

FIG. 20 is a schematic sectional side view showing one modification embodiment of the sensor device.

FIG. 21 is a schematic sectional side view showing other modification embodiment of the sensor device.

FIG. 22 is a schematic sectional side view showing an exemplary structure of a sensor device according to a fifth embodiment of the present technology.

FIG. 23 is a schematic sectional side view showing other exemplary structure of the sensor device.

FIG. 24 is a schematic sectional side view showing other exemplary structure of the sensor device.

FIG. 25 is a schematic sectional side view showing other exemplary structure of the sensor device.

FIG. 26 is a schematic sectional side view showing other exemplary structure of the sensor device.

FIG. 27 is a schematic sectional side view of the first support in the sensor device.

FIG. 28 is a schematic sectional side view showing other exemplary structure of the sensor device.

FIG. 29 is a schematic sectional side view showing other exemplary structure of the sensor device.

### MODE(S) FOR CARRYING OUT THE INVENTION

Hereinafter, embodiments of the present technology will be described with reference to the drawings.

### First Embodiment

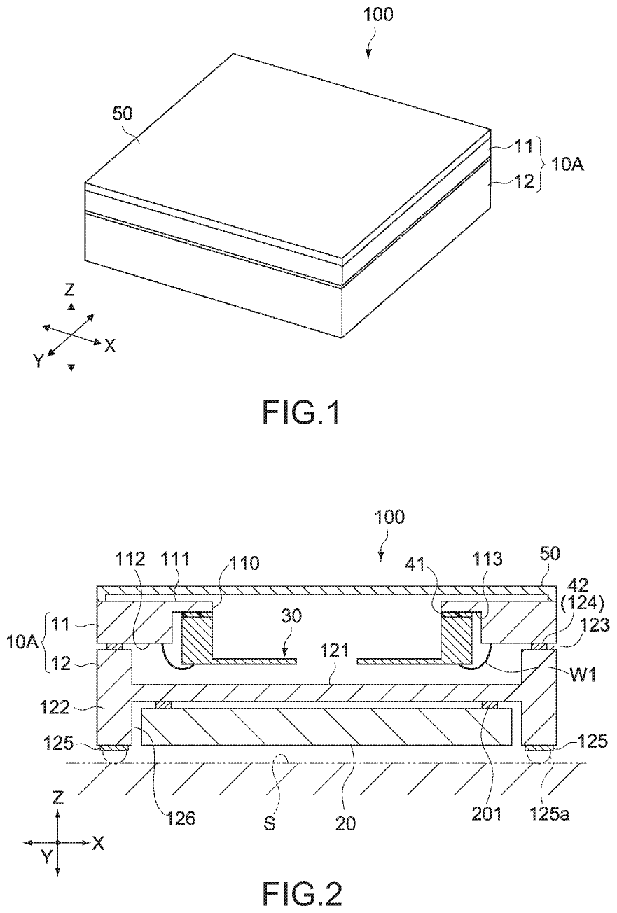

FIG. 1 is a schematic perspective view showing an overall structure of a sensor device according to a first embodiment of the present technology and FIG. 2 is a schematic sectional side view of the sensor device.

Note that the X axis, the Y axis, and the Z axis show three axial directions orthogonal each other in each drawing, and the Z axis corresponds to a height direction (thickness direction) of the sensor device.

A sensor device 100 in this embodiment is built in an electronic apparatus, for example, a moving body such as a vehicle and an air craft, a mobile information terminal such as a smartphone, a digital camera, a sensor head part in a movement measuring device, or the like. The sensor device 100 is mounted to a circuit substrate (control substrate) S in the electronic apparatus together with other electronic components, and has a structure that outputs a detection signal relating to physical quantity such as acceleration, angular velocity, a pressure, or the like used for controlling the electronic apparatus.

Hereinafter, the present embodiment illustrates that the sensor device 100 is an angular velocity sensor.

[Basic Structure]

As shown in FIG. 1 and FIG. 2, the sensor device 100 is formed in a substantially rectangular parallelepiped shape. The sensor device 100 includes a sensor element 30, a package body 10A, first buffers 41, and second buffers 42.

The sensor device 100 in this embodiment further includes a controller 20 for controlling driving of the sensor element 30 and a cap 50 attached to the package body 10A.

In the sensor device 100, the sensor element 30 detects input physical quantity (angular velocity in this embodiment).

The package body 10A includes a first support 11 and a second support 12. The first support 11 is electrically connected to the sensor element 30 and supports the sensor element 30. The second support 12 is electrically connected to the first support 11 and supports the first support 11.

The first buffers 41 are arranged between the sensor element 30 and the first support 11 and elastically connect the sensor element 30 to the first support 11.

The second buffers 42 are arranged between the first support 11 and the second support 12 and elastically connect the first support to the second support 12.

The sensor element 30 includes a gyro sensor element capable of detecting the angular velocity and, in particular, includes a multiaxial sensor element capable of detecting the angular velocity around the three axes, XYZ. Note that the sensor element 30 will be described in detail later.

The first support 11 and the second support 12 form an outer wall of the sensor device 100 and enclose the sensor element 30.

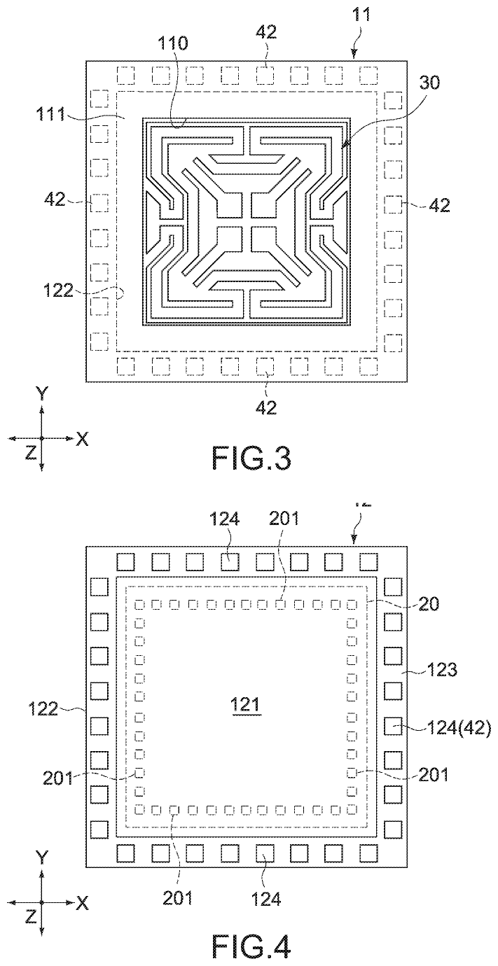

FIG. 3 is a schematic plan view of the first support 11, which corresponds to a plan view of the sensor device 100 with the cap 50 being removed. FIG. 4 is a schematic plan view of the second support 12, which corresponds to the plan view of the sensor device 100 with the cap 50 and the first support 11 being removed.

Any of the first and second supports 11 and 12 includes a wiring board having a substantially rectangular plane shape containing ceramics (alumina). In particular, the second support 12 includes a multilayer wiring board having inner vias (interlayer connection parts). Note that the material of any of the first and second supports 11 and 12 is not limited thereto and may be other electrically insulating material such as glass and plastic, and a semiconductor substrate such as silicon may be used.

The first support 11 includes a rectangular opening 110 at the center, as shown in FIG. 3. the opening 110 includes a through-hole passing through an upper surface 111 and lower surface 112 of the first support 11 (see FIG. 2). On a periphery of the opening 110 at the lower surface 112 of the first support 11, a mount surface 113 to which the sensor element 30 is mounted is provided. The mount surface 113 includes a concave bottom surface arranged in the lower surface 112.

On the other hand, the second support 12 includes a horizontal wall 121 and a vertical wall 122 perpendicular to the horizontal wall 121 and is formed to have a substantially H-shaped cross-section as shown in FIG. 2. The horizontal wall 121 is formed of a rectangular flat plate in parallel with the XY plane. The vertical wall 122 is formed of a peripheral wall formed along a periphery of the horizontal wall 121. The vertical wall 122 is protruded both upward and downward respectively from the periphery of the upper surface and the lower surface of the horizontal wall 121.

Note that to partition the lower surface of the horizontal wall 121 into a plurality of areas, the vertical wall 122 may be formed of a plurality of lines and the like.

The upper surface (upper end) of the vertical wall 122 forms a support surface 123 that supports the first support 11. The support surface 123 is a flat surface formed on the upper surface of the vertical wall 122 in parallel with the horizontal wall 121 and includes a plurality of relay terminals 124 therein arranged along the periphery of the horizontal wall 121 (FIG. 4). A lower surface (lower end) of the vertical wall 122 includes a plurality of external connection terminals 125 connected to a land of a circuit substrate S of the electronic apparatus (FIG. 2). Note that, each external terminal 125 includes a bump 125a and is connected to the circuit substrate S via the bump 125a.

Each first buffer 41 is formed of a rectangular annular-shaped elastic body arranged on the mount surface 113 of the first support 11. The sensor element 30 is supported by the first support 11 via the first buffers 41 and is also electrically connected to the first support 11 via bonding wires W1.

Eahc first buffer 41 is formed of, for example, an adhesive or tacky resin material having an elastic modulus smaller (lower) than those of the first support 11 and each second buffer 42. The resin material may be a hardened material of paste resin or may have a sheet or film shape. The above-described paste resin may be continuously coated in a rectangular annular shape or may be partially coated on four corners of the rectangle. Each first buffer 41 is formed of the electrically insulating material but may have a conductivity.

In this embodiment, the elastic modulus of each first buffer 41 is about 100 MPa, but is not limited thereto, and is set to an appropriate value from 1 MPa to 1000 MPa, for example. A thickness of each first buffer 41 is not especially limited and is, for example, 3 μm or more, preferably 5 μm or more.

Each second buffer 42 is formed of an elastic material arranged on the support surface 123 of the second support 12. In this embodiment, each second buffer 42 is formed of a metal bump arranged on each relay terminal 124. As the metal bump, a solder bump such as a ball bump and a plated bump is usable. In addition, the relay terminals 124 may be sealed by injecting a soft resin material between the metal bumps. Thus, a moisture resistance of the sensor device 100 may be improved. This structure is similarly applicable to third and fifth embodiments and so on described later.

Note that each second buffer 42 is formed not only of the metal bump but also of adhesive conductive resin such as an anisotropic conductive film (ACF), for example. In this case, the ACF may be arranged separately on each relay terminal 124 or may be arranged commonly on each relay terminal 124.

The controller 20 is formed of a circuit element such as an IC component that drives the sensor element 30 and processes a signal detected by the sensor element 30. The controller 20 is enclosed in a space of the package body 10A partitioned by the horizontal wall 121 and the vertical wall 122 of the second support 12.

The controller 20 is electrically and mechanically connected to the second support 12 via connection terminals 201 by flip-chip mounting to the lower surface of the horizontal wall 121. To be more specific, the controller 20 is electrically connected to the sensor element 30 via the second support 12, the relay terminals 124 (second buffers 42), the first support 11, and the bonding wires W1, and is also electrically connected to the circuit substrate S of the electronic apparatus via the second support 12 and the external connection terminals 125.

The cap 50 is attached to the package body 10A (first support 11 in this embodiment) so as to cover the sensor element 30 from the above. The cap 50 is typically formed of a metal material such as stainless steel and an aluminum alloy, has a rectangular shallow dish shape, and is fixed to the periphery of the upper surface 111 of the first support 11 via an adhesive or the like in this embodiment. As the adhesive, a conductive material such as silver paste is preferable. By connecting the cap 50 to a ground terminal on the circuit substrate S via the first support 11, the second buffers 42, the second support 12, and the external connection terminals 125, the cap 50 is allowed to function as an electromagnetic shield.

[Sensor Element]

Next, the sensor element 30 will be described in detail.

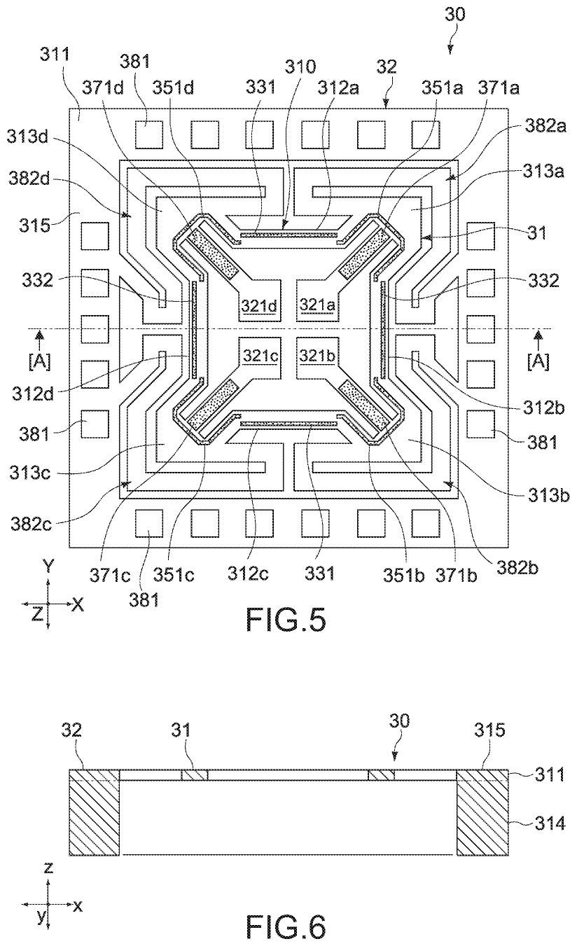

FIG. 5 is a schematic plan view showing one exemplary structure of the sensor element 30 and FIG. 6 is a schematic sectional view taken along the line [A]-[A] of FIG. 5. Hereinafter, with reference to FIG. 5, the structure of the sensor element 30 will be described.

The sensor element 30 is typically formed of a SOI (Silicon On Insulator) substrate and has a laminate structure of an active layer (silicon substrate) forming a main surface 311, a frame-shaped support layer (silicon substrate) forming a support 314 at an opposite side, and a bonding layer (silicon oxide film) (not shown) bonding the main surface 311 and the support 314 as shown in FIG. 6. The main surface 311 and the support 314 have different thicknesses each other and the support 314 is formed thicker than the main surface 311.

The sensor element 30 includes an oscillator body 31 oscillating at a predetermined drive frequency and a framework 32 oscillatably supporting the oscillator body 31.

The oscillator body 31 is arranged at the center of the main surface 311 and is formed by processing the active layer forming the main surface 311 in a predetermined shape. A periphery of the main surface 311 faces to the support 314 in the Z axis direction, and the main surface 311 and the support 314 form the base 315. Note that, the lower surface in FIG. 6 (upper surface in FIG. 2) of the base 315 is a bonding surface to the mount surface 113 of the first support 11.

The oscillator body 31 includes a rectangular annular-shaped frame 310 and a plurality of pendulums 321a, 321b, 321c, and 321d.

The frame 310 includes a first set of beams 312a and 312c and a second set of beams 312b and 312d. The first beams 312a and 312c form one pair of opposite sides extending in parallel in the X axis direction and facing each other in the Y axis direction in FIG. 5. The second beams 312b and 312d form the other pair of opposite sides extending in the Y axis and facing each other in the X axis direction. Each of the beams 312a to 312d has the same length, width, and the thickness, respectively, and a cross section of each beam is formed in a substantial rectangular shape perpendicular in the longitudinal direction of each beam.

At sites corresponding to four corners of the frame 310, a plurality of (four in this embodiment) connections 313a, 313b, 313c, and 313d are formed respectively that connect the beams 312a to 312d. To be more specific, the beams 312a to 312d function as oscillation beams with both ends being supported by the connections 313a to 313d.

Pendulums 321a to 321d are formed of cantilevers with one ends being supported by the connections 313a to 313d. Typically, each of the pendulums 321a to 321d has the same shape and size and is formed at the same time of processing an external shape of the frame 310.

The pendulums 321a and 321c are supported by a pair of the connections 313a and 313c having a diagonal relationship, respectively, protrude along the diagonal line direction toward the center of the frame 310, and face each other at around the center of the frame 310. On the other hand, the pendulums 321b and 321d are supported by a pair of the connections 313b and 313d having a diagonal relationship, respectively, protrude along the diagonal line direction toward the center of the frame 310, and face each other at around the center of the frame 310.

A framework 32 includes an annular base 315 arranged around the oscillator body 31 and a plurality of connectors 382a, 382b, 382c, and 382d arranged between the oscillator body 31 and the base 315.

The base 315 is formed of a quadrangular-shaped framework surrounding outside of the oscillator body 31. On a principal surface (main surface 311) of the base 315, there are arranged a plurality of terminals (electrode pads) 381 electrically connected via a conductive material such as the bonding wires W1 and the metal bumps with respect to connection pads arranged on the lower surface 112 of the first support 11.

The connectors 382a to 382d are arranged between the connections 313a to 13d of the frame 310 and the base 315 and are deformably formed mainly in the XY plane by receiving the oscillation of the frame 310. In other words, the connectors 382a to 382d function as suspensions that oscillatably support the oscillator body 31.

The oscillator body 31 includes a plurality of piezoelectric drivers 331 and 332 that cause the frame 310 to oscillate in a plane in parallel with the main surface 311. The piezoelectric drivers 331 are arranged on surfaces of the first beams 312a and 312c, respectively, and the piezoelectric drivers 332 are arranged on surfaces of the second beams 312b and 312d, respectively.

The piezoelectric drivers 331 and 332 have the same structure, respectively, and are formed of strip shapes in parallel with the longitudinal directions of the beams 312a to 312d. Each of the piezoelectric drivers 331 and 332 has a laminate structure including a lower electrode layer, a piezoelectric film, and an upper electrode layer. The piezoelectric drivers 331 and 332 mechanically deform in response to an input voltage from the controller 20 and deformation driving forces causes to oscillate the beams 312a to 312d.

Specifically, mutually opposite phase voltages are applied to the piezoelectric drivers 331 and 332 such that one is expanded and the other is contracted. Thus, in a case where the first set of beams 312a and 312c oscillate in a manner such that they are getting closer each other, the second set of beams 312b and 312d oscillate in a manner such that they are separated from each other. In a case where the first set of beams 312a and 312c oscillate in a manner such that they are separated from each other, the second set of beams 312b and 312d oscillate in a manner such that they are getting closer each other. Such an oscillation mode is hereinafter referred to as fundamental oscillation of the frame 10.

The oscillator body 31 further includes a plurality of first piezoelectric detectors 351a, 351b, 351c, and 351d and a plurality of second piezoelectric detectors 371a, 371b, 371c, and 371d.

The first piezoelectric detectors 351a to 351d (angular velocity detectors) are arranged on the four connections 313a to 313d, respectively, and detect an angular velocity around the Z axis perpendicular to the main surface 311 on the basis of a deformation amount of the main surface 311 of the frame 310. The second piezoelectric detectors 371a to 371d are arranged on the surfaces of the respective pendulums 321a to 321d, respectively, and detect angular velocities around two axes (e.g., X axis and Y axis) perpendicular to the Z axis on the basis of a deformation amount of the respective pendulums 321a to 321d in the Z axis direction.

Each of the first piezoelectric detectors 351a to 351d and the second piezoelectric detectors 371a to 371d has the similar structure of a laminate including a lower electrode layer, a piezoelectric film, and an upper electrode layer, and has a function to convert a mechanical deformation of each of the pendulums 321a to 321d into an electric signal and to output it to the controller 20.

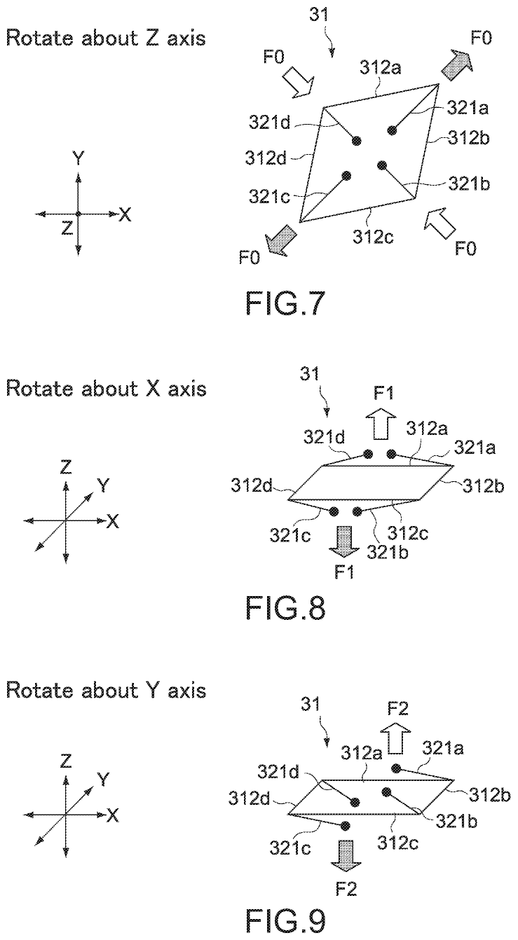

In the gyro sensor element 30 in this embodiment, in a case where the angular velocity is generated around the Z axis of the frame 310 that fundamentally oscillates, Coriolis force F0 caused by the angular velocity acts on each point of the frame 310, as shown in FIG. 7. With this actions, the frame 310 deforms and is distorted in the XY plane, as shown in FIG. 7. Thus, by detecting the deformation amount of the frame 310 in the XY plane with the first piezoelectric detectors 351a to 351d, it becomes possible to detect a magnitude and a direction of the angular velocity around the Z axis acted on the frame 310.

In addition, in a case where the angular velocity around the X axis acts on the frame 310 that fundamentally oscillates, Coriolis force F1 is generated in each of pendulums 321a to 321d in the direction perpendicular to an oscillation direction at that moment, as schematically shown in FIG. 8. Thus, one set of the pendulums 321a and 321d adjacent in the X axis direction deforms in a positive direction of the Z axis by the Coriolis force F1 and deformation amounts thereof are respectively detected by the second piezoelectric detectors 371a and 371d. Furthermore, the other set of the pendulums 321b and 321c adjacent in the X axis direction deforms in a negative direction of the Z axis by the Coriolis force F1 and deformation amounts thereof are respectively detected by the second piezoelectric detectors 371b and 371c.

Similarly, in a case where the angular velocity around the Y axis acts on the frame 310 that fundamentally oscillates, Coriolis force F2 is generated in each of pendulums 321a to 321d in the direction perpendicular to an oscillation direction at that moment, as schematically shown in FIG. 9. Thus, one set of the pendulums 321a and 321b adjacent in the Y axis direction deforms in a positive direction of the Z axis by the Coriolis force F2 and deformation amounts thereof are respectively detected by the second piezoelectric detectors 371a and 371b. Furthermore, the other set of the pendulums 321c and 321d adjacent in the Y axis direction deforms in a negative direction of the Z axis by the Coriolis force F1 and deformation amounts thereof are respectively detected by the second piezoelectric detectors 371c and 371d.

Note that even in a case where angular velocities are generated around the axes in the directions respectively obliquely crossing with the X axis and the Y axis, the angular velocities are detected on the basis of the principle similar to that described above. Specifically, each of the pendulums 321a to 321d deforms by the Coriolis force corresponding to an X direction component and a Y direction component. The deformation amounts are respectively detected by the piezoelectric detectors 371a to 371d. The controller 20 extracts the angular velocity around the X axis and the angular velocity around the Y axis on the basis of the outputs from the piezoelectric detectors 371a to 371d. Thus, it becomes possible to detect the angular velocity around any axis in parallel with the XY plane.

### Action of Sensor Device

In the sensor device 100 in this embodiment, the package body 10A has a laminate structure of the first support 11 and the second support 12 bonded via the second buffers 42, and the sensor element 30 is bonded to the first support 11 via the first buffers 41. Accordingly, it prevents an external stress (bending stress, thermal stress) from directly transmitting to the sensor element 30 from the circuit substrate S. Thus, an effect of the external stress can be reduced and stable detection accuracy of the sensor element 30 can be ensured.

According to this embodiment, since each of the first and second supports 11 and 12 is formed of the ceramic substrate, bending rigidity is high with respect to the external stress from the circuit substrate S as compared with a silicon substrate and the like.

Moreover, the first support 11 includes a concave part having the mount surface 113 and has a structure that the deformation of the first support 11 is hard to be transmitted to the mount surface 113 (sensor element 30). Also, the second support 12 includes the horizontal wall 121 and the vertical wall 122 and has a three-dimensional structure having durability with respect to the deformation. With this structure of the package body 10A, the sensor element 30 is less susceptible to the effect of the external stress. Thus, a highly accurate detection signal can be stably outputted.

Furthermore, since each first buffer 41 is formed of the material having the elastic modulus lower than that of each second buffer 42, it becomes possible to reduce the stress applied to the sensor element 30 as low as possible.

Furthur, in this embodiment, the sensor element 30 is supported by the first support 11 and the controller 20 is supported by the second support 12. Thus, a stress and heat from the controller 20 are not applied to the sensor element 30 as compared with the case that the sensor element 30 is directly supported on the controller 20. Accordingly, it is possible to ensure a stable output of the sensor element 30.

### Modification Embodiment 1-1

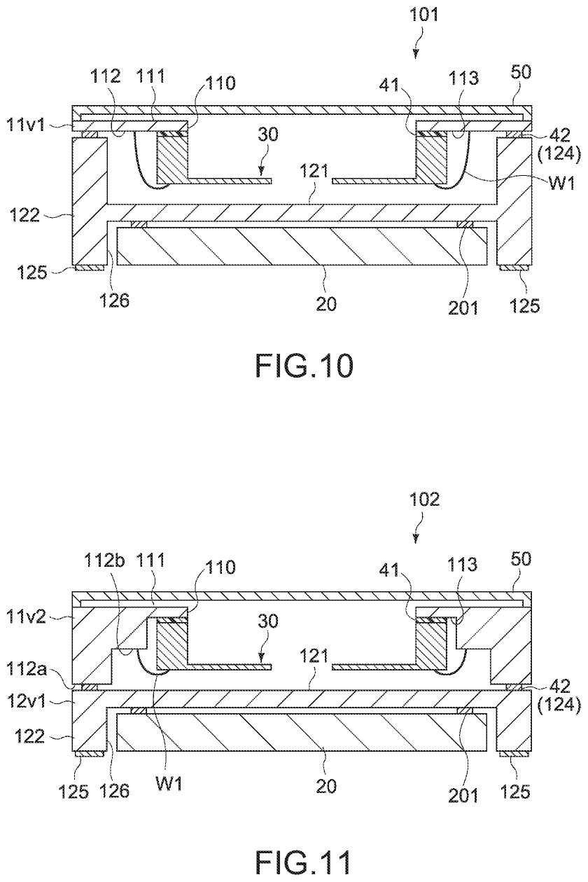

FIG. 10 is a schematic sectional side view of a sensor device according to a modification embodiment of the first embodiment. As shown in FIG. 10, a first support 11v1 of a sensor device 101 according to the modification embodiment is different from the first support 11 of the sensor device 100 in that the first support 11v1 has a flat plate shape. In the modification embodiment, the mount surface 113 to which the sensor element 30 is mounted is coplanar with the lower surface 112 of the first support 11v1.

In the sensor device 101 according to the modification embodiment, the sensor element 30 is supported by the first support llvl via the first buffers 41 and the first support 11v1 is supported by the second support 12 via the second buffers 42. Thus, the functions and effects similar to those of the above-described sensor device 100 can be provided. According to the modification embodiment, the first support 11v1 is formed in the flat plate shape. Therefore, it becomes easy to mount the sensor element 30 with respect to the mount surface 113 and desirable mounting accuracy can be ensured.

### Modification Embodiment 1-2

FIG. 11 is a schematic sectional side view of a sensor device according to other modification embodiment of the first embodiment. As shown in FIG. 11, a sensor device 102 according to the modification embodiment is different from the sensor device 100 in that a first support 11v2 has a step from the lower surface 112a, i.e., a terminal surface 112b bonding with the bonding wires W1. In this case, the first support 11v2 if formed of a multilayer wiring board and the lower surface 112a is electrically connected to the terminal surface 112b via an internal via.

Note that, a second support 12v1 has a structure different from the above-described second support 12 in that the vertical wall 122 is protruded only downward from the periphery of the horizontal wall 121.

Also, in the sensor device 101 according to the modification embodiment, the functions and effects similar to those of the above-described sensor device 100 can be provided. According to the modification embodiment, since the terminal surface 112b connecting to the bonding wires W1 is provided to the lower surface 112a of the first support 11v2 via the step, it ensures a predetermined gap to avoid a contact between the bonding wires W1 electrically connecting the sensor element 30 to the first support 11v2 and the horizontal wall 121 of the second support 12v1.

### Second Embodiment

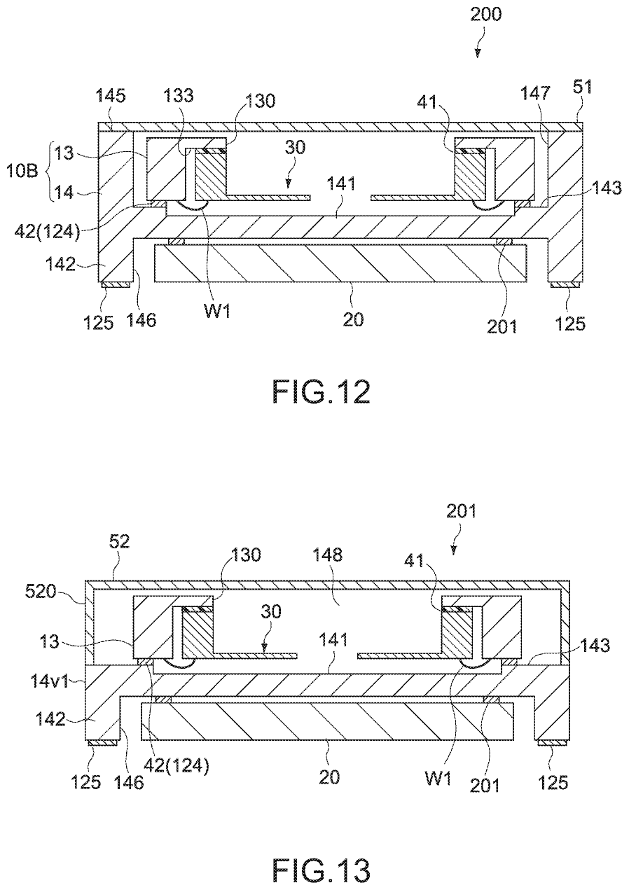

FIG. 12 is a schematic perspective view showing a sensor device according to a second embodiment of the present technology. Hereinafter, structures different from the first embodiment will be mainly described. Structures similar to the first embodiment are denoted by the similar reference signs, and description thereof will be omitted or simplified.

A sensor device 200 according to the second embodiment includes the sensor element 30, a package body 10B, the first buffers 41, the second buffers 42, the controller 20, and a cap 51 similar to the first embodiment. The package body 10B includes a first support 13 and a second support 14. The second embodiment is different from the first embodiment in that the cap 51 is bonded to the second support 14.

The first support 13 is enclosed inside the second support 14. The first support 13 is formed of a ceramic wiring board having a cross-sectional shape similar to that of the first embodiment. At a lower surface periphery of the opening 130 of the first support 13, a mount surface 133 to which the sensor element 30 is mounted is provided.

A second support 14 has a cross-sectional shape similar to that of the first embodiment and is formed of a ceramic multilayer wiring board including a horizontal wall 141 and a vertical wall 142 provided at the periphery.

The second support 14 includes a space 146 that encloses the controller 20 and an upper space 147 that encloses the first support 13. The controller 20 is electrically and mechanically connected to the second support 14 via connection terminals 201 by flip-chip mounting to the lower surface of the horizontal wall 141, similar to the first embodiment. The first support 13 is bonded to the support surface 143 arranged on an upper surface periphery of the horizontal wall 141 via the second buffers 42.

The support surface 143 is formed of a plane in parallel with the horizontal wall 141 and is formed of a rectangular annular-shaped plane formed via a step with respect to an upper surface of the horizontal wall 141 in the second embodiment. Thus, it ensures a predetermined gap to avoid a contact between the bonding wires W1 electrically connecting the sensor element 30 to the first support 13 and the horizontal wall 141.

It is not limited to this and the support surface 143 may be coplanar with the upper surface of the horizontal wall 141. In this case, each second buffer 42 may be thicker. The second buffers 42 are formed of a plurality of the metal bumps provided on a plurality of the relay terminals 124 on the support surface 143 similar to the first embodiment.

The cap 51 is attached to the package body 10B so as to cover the sensor element 30 from the above. In the second embodiment, the cap 51 is bonded to the second support 14. The cap 51 is formed of a rectangular metal plate having a predetermined thickness and is fixed to an upper surface 145 of the vertical wall 142 of the second support 14 via an adhesive or the like.

Also, in the sensor device 200 having the above-described structure according to this embodiment, the functions and effects similar to the above-described first embodiment can be provided.

According to the second embodiment, since the first support 13 is enclosed in the second support 14, it can be avoided that an external force directly acts on the first support 13. In addition, since the cap 51 is attached to the second support 14, it prevents a stress applied to the cap 51 from directly transmitting to the first support 13 and the sensor element 30.

### Modification Embodiment 2-1

FIG. 13 is a schematic sectional side view of a sensor device according to a modification embodiment of the second embodiment. As shown in FIG. 13, in a sensor device 201 according to the modification embodiment, a second support 14v1 has a structure that the vertical wall 142 is protruded only downward from the periphery of the horizontal wall 141. In this case, a cap 52 bonded to an upper surface of the second support 14v1 has a peripheral wall 520 forming a space 148 that encloses the first support 13.

Also, in the sensor device 201 according to the modification embodiment, the functions and effects similar to those of the above-described sensor device 200 can be provided. According to the modification embodiment, since the upper surface of the second support 14v1 is formed in a substantially flat plate shape, the first support 13 is advantageously mounted to the support surface 143 easily.

### Modification Embodiment 2-2

FIG. 14 is a schematic sectional side view of a sensor device according to a modification embodiment of the second embodiment. As shown in FIG. 14, in a sensor device 202 according to the modification embodiment, a second support 14v2 has a structure that the vertical wall 142 is protruded only upward from the periphery of the horizontal wall 141. In this case, to the upper surface of the vertical wall 142, the cap 52 is bonded and the first support 13 is electrically and mechanically connected at an inner periphery of a bonded area via the second buffers 42 (relay terminals 124).

On the other hand, the controller 20 is mounted to the upper surface of the horizontal wall 141 and a plurality of the external connection terminals 125 electrically connected to the controller 20 and the sensor element 30 are arrayed in a grid form at the lower surface of the horizontal wall 141. The cap 52 forms a space 149 that encloses the first support 13 and the controller 20 together with the second support 14v2.

Also, in the sensor device 202 according to the modification embodiment, the functions and effects similar to those of the above-described sensor device 200 can be provided. According to the modification embodiment, since the horizontal wall 141 of the second support 14v2 forms a lowest surface of the sensor device 202, a degree of freedom in the array of the external connection terminals 125 can be improved.

### Third Embodiment

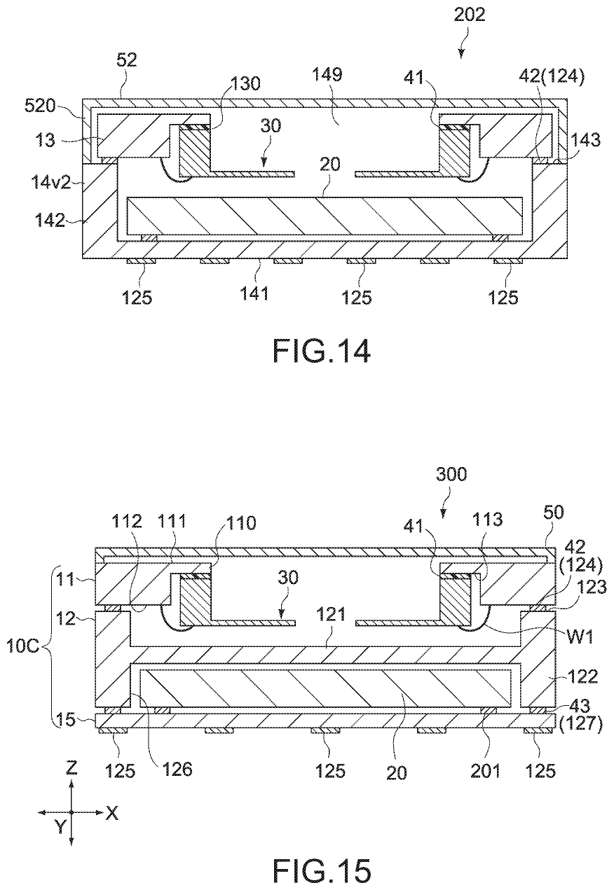

FIG. 15 is a schematic sectional side view showing a sensor device according to a third embodiment of the present technology. Hereinafter, structures different from the first embodiment will be mainly described. Structures similar to the first embodiment are denoted by the similar reference signs, and description thereof will be omitted or simplified.

A sensor device 300 of this embodiment includes the sensor element 30, a package body 10C, the first buffers 41, the second buffers 42, the controller 20, and the cap 50 similar to the first embodiment. This embodiment is different from the first embodiment in that a third support 15 and third buffers 43 are further included.

The package body 10C has a laminate structure of the first support 11, the second support 12, and a third support 13.

The third support 15 is typically formed of a ceramic-based multilayer wiring board. At an upper surface thereof, relay terminals 127 electrically connected to the second support 12 are arranged facing to a lower surface of the vertical wall 122. At a lower surface of the third support 15, the external connection terminals 125 electrically connected to the relay terminals 127 are arrayed in a grid form. The third support 15 is connected to the lower surface of the vertical wall 122 of the second support 12 via the third buffers 43.

The third buffers 43 are arranged between the second support 12 and the third support 15 and elastically connect the second support 12 to the third support 15. The third buffers 43 are formed of a plurality of metal bumps arranged on the respective relay terminals 127, but are not limited thereto, and may be formed of an adhesive conductive material such as an anisotropic conductive film (ACF).

The third support 15 forms a space 126 between the third support 15 and the second support 12 that encloses the controller 20. The connection terminals 201 of the controller 20 are connected to the upper surface of the third support 15 but may be connected to the second support 12 (horizontal wall 121) similar to the first embodiment. Since the controller 20 is connected to the third support 15, a wiring length between the controller 20 and each of the external terminals 125 can be shorten and electric properties (high frequency properties) can be improved. In addition, while the sensor element 30 and the controller 20 are held in other cavity (space), a degree of freedom in an arrangement of the external terminals 125 can be improved.

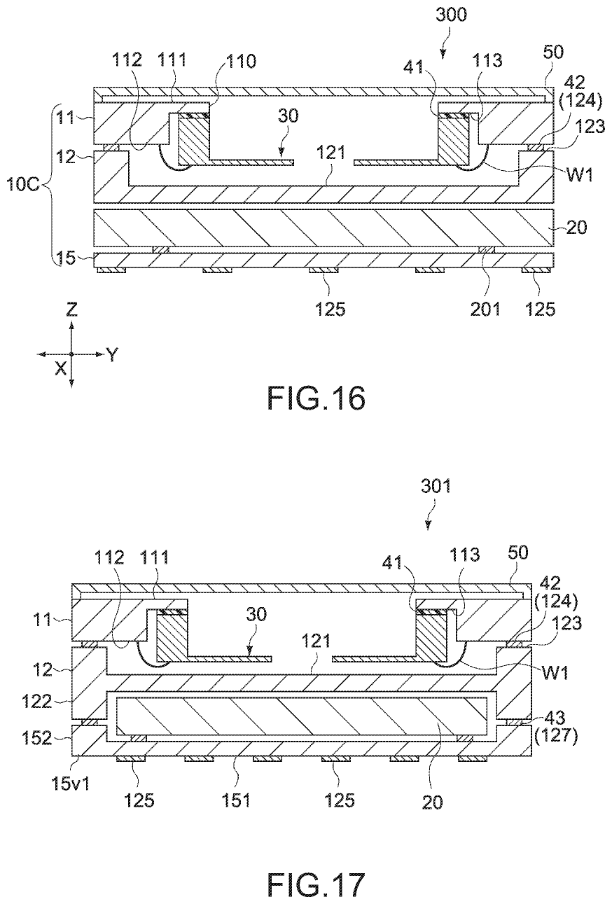

Note that the vertical wall 122 of the second support 12 is formed of a rectangular peripheral wall, but is not limited to the embodiment. The horizontal wall 121 may include only two sides faced each other (in this embodiment, two sides faced in the X axis direction). In this case, since the horizontal wall 121 may include no vertical wall 122 arranged at other two sides faced each other (two sides faced in the Y axis direction) as shown in FIG. 16, it can be possible to increase an enclosure space and an area of the controller 20.

Also, in the sensor device 300 having the above-described structure according to this embodiment, the functions and effects similar to those of the above-described sensor device 100 can be provided.

According to this embodiment, since the package body 10C further includes the third support 15 connected to the second support 12 via the third buffers 43, overall rigidity of the package body 10C is further improved and it is possible to more effectively suppress transmission of the stress to the sensor element 30.

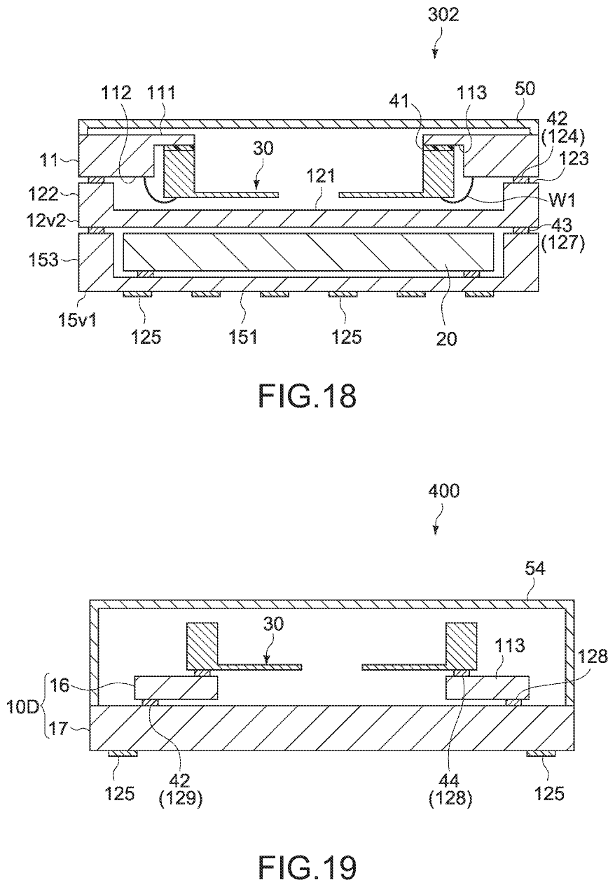

Note that the third support 15 is not limited to the flat plate shape as described above. As shown in FIG. 17 and FIG. 18, third supports 15v1 and 15v2 having vertical walls 152 and 153 may be formed. Thus, it can be possible to further improve rigidity of the third supports 15v1 and 15v2.

### Modification Embodiment 3-1

FIG. 17 is a schematic sectional side view of a sensor device according to a modification embodiment of the present embodiment. As shown in FIG. 17, in a sensor device 301 according to this embodiment, the third support 15v1 includes a horizontal wall 151 that supports the controller 20 and a vertical wall 152 protruding upward from a periphery of the horizontal wall 151. On an upper surface of the vertical wall 152, the third buffers 43 (relay terminals 127) mechanically and electrically connected to the second support 12 are arranged.

### Modification Embodiment 3-2

Similarly, in a sensor device 302 shown in FIG. 18, the third support 15v2 includes the horizontal wall 151 and the vertical wall 153. On an upper surface of the vertical wall 153, the third buffers 43 (relay terminals 127) are mechanically and electrically connected to a second support 12v2. Note that the vertical wall 122 of the second support 12v2 in this embodiment has a structure that the vertical wall 122 is protruded only upward from the periphery of the horizontal wall 121.

Also, in the sensor devices 301 and 302 having the above-described structures according to the present embodiments, the functions and effects similar to those of the above-described sensor device 100 can be provided. According to the present embodiments, since the third supports 15v1 and 15v2 have three-dimensional structures including the vertical walls 152 and 153, rigidity of a whole package can be improved.

### Fourth Embodiment

FIG. 19 is a schematic sectional side view showing a sensor device according to a fourth embodiment of the present technology. Hereinafter, structures different from the first embodiment will be mainly described. Structures similar to the first embodiment are denoted by the similar reference signs, and description thereof will be omitted or simplified.

A sensor device 400 of this embodiment includes the sensor element 30, a package body 10D, first buffers 44, second buffers 42, and a cap 54 similar to the first embodiment. This embodiment is different from the first embodiment with respect to a structure of the package body 10D and in that no controller 20 is included.

The package body 10D of this embodiment includes a first support 16 and a second support 17. As shown in FIG. 17, in the sensor device 400, the sensor element 30 is supported by a first support 16 via the first buffers 44 and the first support 16 is supported by a second support 17 via the second buffers 42.

In this embodiment, the sensor element 30 is electrically and mechanically connected to the mount surface 113 that is the upper surface of the first support 16 by flip-chip mounting. In this case, each first buffer 44 may be a metal bump or an anisotropic conductive film (ACF). Each first buffer 44 may have the structure similar to that of each second buffer 42 or may be formed of a material having elastic modulus lower than that of the second buffer.

The first support 16 and the second support 17 are formed of a flat plate-shaped ceramic multilayer wiring board. On an upper surface and a lower surface of the first support 16, relay terminals 128 electrically connected to the first buffers 44 and the second buffers 42 are arranged. On an upper surface of the second support 17, relay terminals 129 electrically connected to the second buffers 42 and external connection terminals 125 connected to the circuit substrate are respectively arranged.

The cap 54 is attached to the package body 10D so as to cover the sensor element 30 from the above. The cap 54 is typically formed of a metal material such as stainless steel and an aluminum alloy and is fixed to the periphery of the upper surface of the second support 17 via an adhesive or the like.

Also, in the sensor device 400 having the above-described structure according to this embodiment, the functions and effects similar to those of the above-described sensor device 100 can be provided.

### Modification Embodiment 4-1

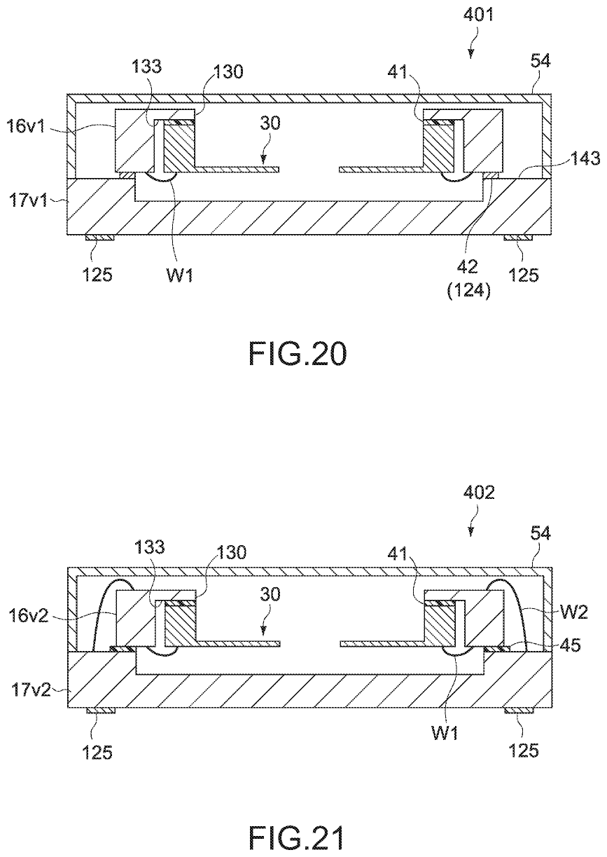

FIG. 20 is a schematic sectional side view showing a sensor device according to a modification embodiment of the present embodiment. As shown in FIG. 20, in a sensor device 401 according to this embodiment, the first support 16v1 has a structure similar to the first support 13 described with reference to FIG. 12 and the second support 17v1 has a structure similar to the second support 12v2 described with reference to FIG. 18. In the present embodiment, since the second support 17v1 has a three-dimensional structure including the vertical wall, rigidity of the second support 17v1 can be improved.

### Modification Embodiment 4-2

FIG. 21 is a schematic sectional side view of a sensor device according to other modification embodiment of the present embodiment. As shown in FIG. 21, in a sensor device 402 according to this embodiment, a first support 16v2 is formed of a ceramic multilayer wiring board, is electrically connected to the sensor element 30 supported via the first buffers 41 via bonding wires W1, and is electrically connected to a second support 17v2 bonded via the second buffers 45 via bonding wires W2. The second support 17v2 has a structure similar to that of the above-described second support 17v1.

In this embodiment, each second buffer 45 is formed of a hardened product of electrically insulating adhesive resin. Each second buffer 45 may be formed of the same material as each first buffer 41 or may be formed of a material having elastic modulus higher (or lower) than that of each first buffer 41.

Also, in the sensor devices 401 and 402 having the above-described structures, the functions and effects similar to those of the above-described sensor device 400 can be provided. According to this embodiment, since the second supports 17v1 and 17v2 have three-dimensional structures including the vertical walls, rigidity of a whole package can be improved.

### Fifth Embodiment

In general, in a sensor device mounting a multi-axis angular velocity sensor element, it needs not only to provide a stress resistance, but also to suppress an effect of other axis sensitivity caused by unnecessary oscillation of the sensor element. In principle, pendulums (corresponding to oscillator body 31 in FIG. 5) ideally oscillate symmetrically in a plane direction (direction in parallel with XY plane in FIG. 5). A working shape may be biased or varied and the oscillation may be asymmetric or include an off-plane direction. Thus, unnecessary oscillation may occur, which results in multiaxial sensitivity.

On the other hand, in an angular velocity sensor element including suspension (corresponding to connectors 382 in FIG. 5) elastically supporting peripheries of the pendulums, the suspension cannot absorb the oscillation of the pendulums and a fixed frame (corresponding to framework 32) may thus oscillate. If the fixed frame oscillates, the oscillation (deformation) of the fixed frame has an effect on a holding status of the oscillator and a package member also oscillates, and the oscillator unstably oscillates. In order to solve the problem, a support for supporting the fixed frame is made to have a robust structure to suppress the oscillation (deformation) of the fixed frame and to hold the oscillator stably. However, an external stress acted on the support will be transmitted to the sensor element without attenuation. Thus, a new problem arises that a stress resistance of the sensor element is lowered.

Accordingly, in the present embodiment, structures of a sensor device will be described that is capable of maintaining a stress resistance of the sensor element 30, suppressing the oscillation (deformation) of the framework 32 that supports the oscillator body 31, and holding an oscillation status of the sensor element 30 stably.

### Exemplary Structure 1

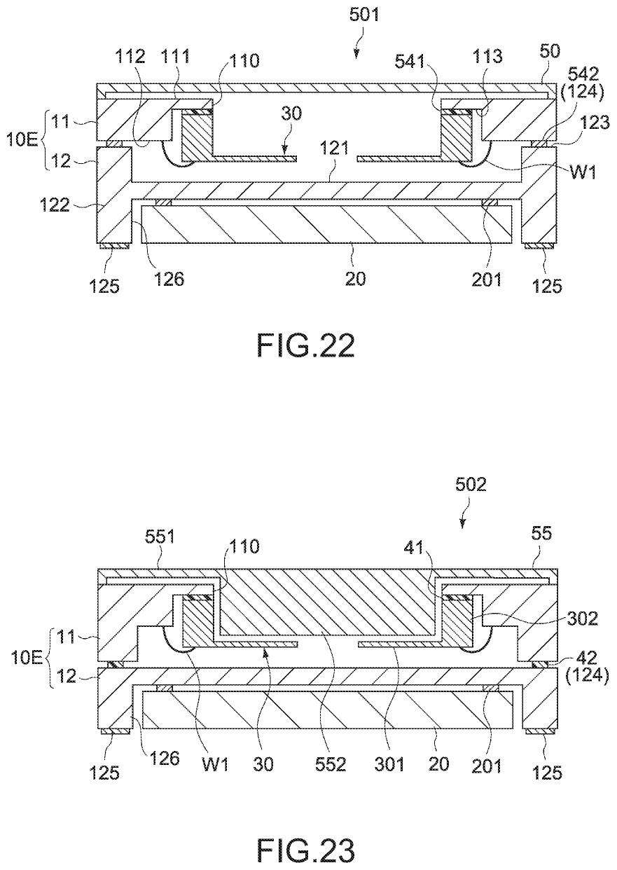

FIG. 22 is a schematic sectional side view showing one exemplary structure of a sensor device according to a fifth embodiment of the present technology. Hereinafter, structures different from the first embodiment will be mainly described. Structures similar to the first embodiment are denoted by the similar reference signs, and description thereof will be omitted or simplified.

A sensor device 501 in this exemplary structure includes the sensor element 30, a package body 10E, first buffers 541, second buffers 542, the controller 20, and the cap 50 similar to the first embodiment.

The package body 10E includes the first support 11 and the second support 12 similar to the first embodiment. The first and second supports 11 and 12 are typically formed of a ceramic material such as alumina or a semiconductor substrate such as silicon.

In a case where the first support 11 is formed of the ceramic material, rigidity of the first support 11 is improved, to thereby effectively suppressing the deformation caused by the external stress and the oscillation caused by self-excited oscillation by the sensor element 30. In addition, in a case where the first support 11 is formed of the silicon substrate, a coefficient of thermal expansion of the first support 11 and a coefficient of thermal expansion of the sensor element 30 may be the same or substantially the same. Thus, a stress on a bonded part between the first support 11 and the sensor element 30 is prevented from increasing even in an environment with great temperature changes and the sensor element 30 can be stably held.

Each first buffer 541 is formed of a rectangular annular-shaped elastic body arranged on the mount surface 113 of the first support 11. The sensor element 30 is supported by the first support 11 via the first buffers 541 and is also electrically connected to the first support 11 via bonding wires W1.

Each first buffer 541 is formed of, for example, an adhesive or tacky resin material. The resin material may be a hardened material of paste resin or may have a sheet or film shape. Each first buffer 541 is formed of the electrically insulating material but may have a conductivity. On the other hand, in a case where the first support 11 is the silicon substrate, each first buffer 541 may be formed of a bonding between the sensor element 30 and the first support 11 such as an eutectic bonding, a solid-state bonding, and a diffusion bonding.

The second buffers 542 are arranged on the support surface 123 of the second support 12. The first support 11 is supported by the second support 12 via the second buffers 542 and is also electrically connected to the second support 12 via the second buffers 542.

In this exemplary structure, each first buffer 541 is formed of a material having elastic modulus greater (higher) than that of each second buffer 542. For example, each first buffer 541 is formed of a relatively high-hardness material such as epoxy resin and acrylic resin. Thus, the bonded part between the first support 11 and the sensor element 30 has improved rigidity and the oscillation of the framework 32 of the sensor element 30 is suppressed. As a result, a stable oscillation status of the oscillator body 31 is held and other axis sensitivity caused by unnecessary oscillation is suppressed from occurring.

On the other hand, each second buffer 542 is formed of a conductive material arranged on each relay terminal 124 on the support surface. Each second buffer 542 is formed of a relatively low-hardness material such as an anisotropic conductive film (ACF), a conductive resin, and conductive rubber. Thus, the external stress transmitted from the circuit substrate (not shown) to the second support 12 is absorbed or attenuated by the second buffers 542 and is suppressed from transmitting to the first support 11. As a result, an effect of the stress on the sensor element 30 is reduced and it ensures to stably detect the angular velocity of the sensor element 30.

As described above, according to the sensor device 501 of this exemplary structure, the oscillation status of the sensor element 30 can be stably held by maintaining the stress resistance of the sensor element 30 and suppressing the oscillation (deformation) of the framework 32 that supports the oscillator body 31.

### Exemplary Structure 2

FIG. 23 is a schematic sectional side view showing other exemplary structure of the sensor device according to the present embodiment. Hereinafter, structures different from the first embodiment will be mainly described. Structures similar to the first embodiment are denoted by the similar reference signs, and description thereof will be omitted or simplified.

A sensor device 502 in this exemplary structure includes the sensor element 30, the package body 10E, the first buffers 41, the second buffers 42, the controller 20, and a cap 55. In this exemplary structure, a structure of the cap 55 is different from the first embodiment.

Note that the first and second supports 11 and 12 of the package body 10E have structures corresponding to the first and second supports 11v2 and 12v1 described with reference to FIG. 11, respectively.

In the sensor device 502 of this exemplary structure, by increasing a mass (weight) of the first support 11 that supports the sensor element 30, the oscillation of the first support 11 from the oscillation transmitted from the sensor element 30 is suppressed, to thereby realizing stale holding of the sensor element 30.

Specifically, in this exemplary structure, the cap 55 includes a cap body 551 and a weight member 552. The cap body 551 is bonded to the upper surface of the first support 11. The weight member 552 is arranged at a center of a lower surface of the cap body 551 and protrudes toward the sensor element 30 via the opening 110 of the first support 11. The weight member 552 is formed of a block having a substantially rectangular parallelepiped shape, is arranged within the framework 32 of the sensor element 30 (support 314 in FIG. 6), and faces to the oscillator body 31 at a predetermined gap.

The weight member 552 is typically formed of a metal material and is formed integrally with the cap body 551. Alternatively, the weight member 552 may be formed of a member different from the cap body 551 and may be bonded to the cap body 51 by adhesion, welding, or the like, for example. In this case, the weight member 552 may be formed not only of the metal material but also of other materials. The weight of the weight member 552 is not especially limited and is preferably set such that a natural frequency of the first support 11 including the cap 55 is sufficiently distant from a resonance frequency of the sensor element 30, for example.

On the other hand, since each second buffer 42 is formed of a material having an elastic modulus smaller (lower) than that of each first buffer 41, efficiency of absorbing the external stress transmitted from the second support 12 to the first support 11 is improved. Thus, the stress resistance of the sensor element 30 is ensured.

Note that even if the mass of the first support 11 is increased, for example, instead of providing the weight 552, the same effect described above can be provided. For example, the first support 11 may be thicker or may be formed of a material having a relatively great specific gravity.

### Exemplary Structure 3

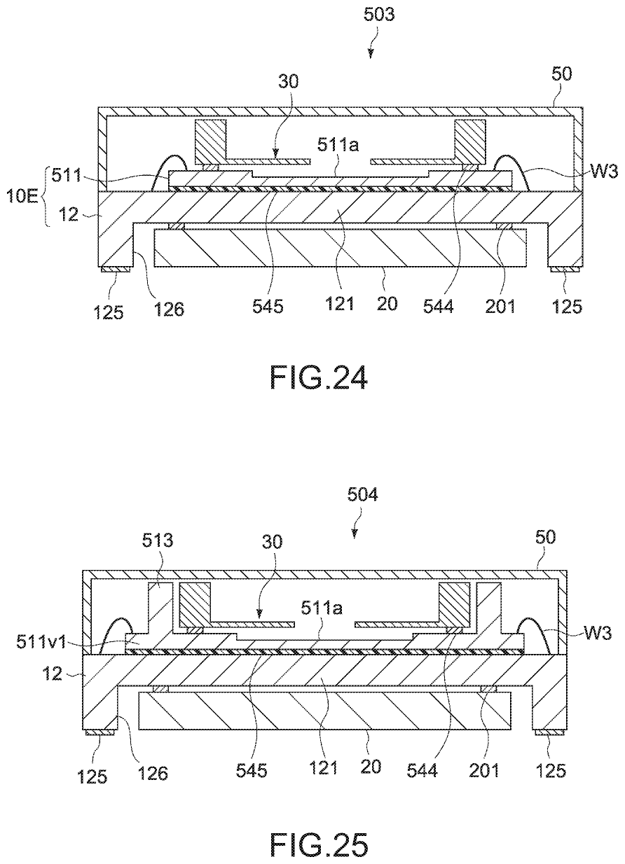

FIG. 24 is a schematic sectional side view showing other exemplary structure of the sensor device according to the present embodiment. Hereinafter, structures different from the first embodiment will be mainly described. Structures similar to the first embodiment are denoted by the similar reference signs, and description thereof will be omitted or simplified.

A sensor device 503 in this exemplary structure includes the sensor element 30, the package body 10E, first buffers 544, a second buffer 545, the controller 20, and the cap 50. In this embodiment, structures of the first buffers 544 and the second buffer 545 are different from the first embodiment.

The package body 10E of this exemplary structure includes a laminate structure of the first support 511 and the second support 12. The first support 511 is formed of a wiring board having a rectangular flat plate shape formed of a ceramic material such as alumina or a semiconductor substrate such as silicon. The first support 511 supports the sensor element 30 via the first buffers 544 and is also electrically connected to the second support 12 via bonding wires W3. At a center of an upper surface of the first support 511, a concave part 511a having a bottom and forming a predetermined gap between the concave part 511a and the sensor element 30 (oscillator body 31) is arranged. Note that, since the second support 12 has the structure similar to that of the exemplary structure 2 (FIG. 23), description thereof will be omitted.

Each first buffer 544 is formed of a conductive material and elastically connects the first support 511 to the sensor element 30. Each first buffer 544 is typically formed of a metal bump, an anisotropic conductive film (ACF), or the like and may be formed of a bonding between the sensor element 30 and the first support 511 such as an eutectic bonding, a solid-state bonding, and a diffusion bonding.

On the other hand, the second buffer 545 is formed of an adhesive resin material having relatively low elasticity. Examples of the adhesive resin material include silicone resin, urethane resin, and the like, for example. The second buffer 545 is provided on the upper surface of the horizontal wall 121 of the second support 12 and elastically supports the lower surface of the first support 511. Note that the second buffer 545 is provided not only as a plane but also as a plurality of dots or lines on the second support 12.

Also, in the sensor device 503 according to this exemplary structure, the functions and effects similar to those of the above-described exemplary structure 1 can be provided.

### Exemplary Structure 4

FIG. 25 is a schematic sectional side view showing other exemplary structure of the sensor device according to the present embodiment. In a sensor device 504 according to the present embodiment, the first support 511v1 has a structure different from that of the above-described exemplary structure 3.

In the sensor device 504 of this exemplary structure, the first support 511v1 has a protrusion 513 that protrudes toward an inner surface of the cap 50 on the upper surface thereof. The protrusion 513 may be formed in a frame shape around the sensor element 30 or may be divided into a plurality of protrusions. The protrusion 513 may be formed integrally with the first support 511v or may be formed as a separate member.

As in this exemplary structure, since the first support 511v1 is three-dimensionally formed as described above, the mass of the first support 511 is increased. Thus, similar to the exemplary structure 2, the sensor element 30 can be stably held.

### Exemplary Structure 5

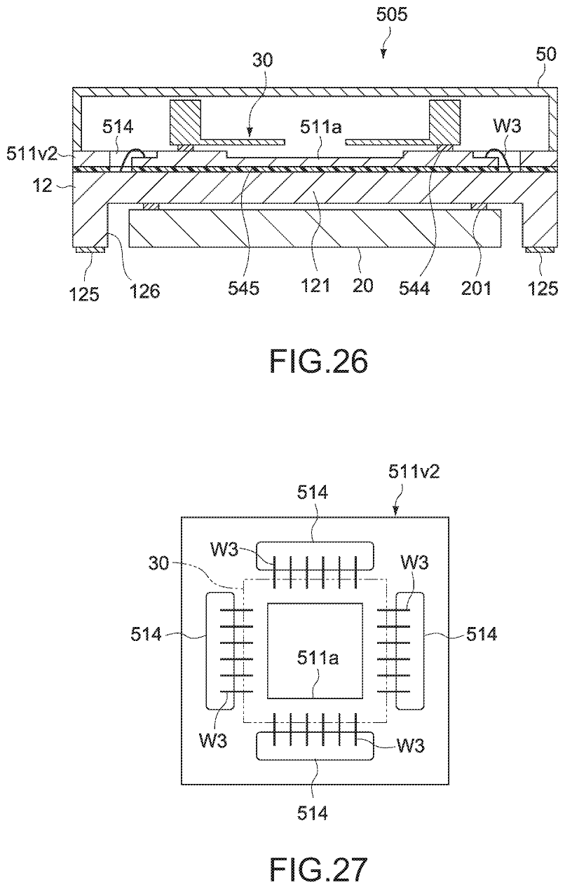

FIG. 26 is a schematic sectional side view showing other exemplary structure of the sensor device according to the present embodiment. In a sensor device 505 of the present embodiment, the structure of a first support 511v2 is different from that of the above-described exemplary structure 3.

In the sensor device 505 of this exemplary structure, the first support 511v2 is formed of a wiring board having a rectangular flat plate shape and the same size as the second support 12 and is bonded to the second support 12 over the entire upper surface via the second buffer 545. Within the first support 511v2, there are provided a plurality of through-holes 514 so as to surround the peripheral of the sensor element 30 as shown in FIG. 27. Via the bonding wires W3 passing through the through-holes 514, the first support 511v2 is electrically connected to the second support 12.

As in this exemplary structure, since the first support 511v2 has an enlarged surface area as described above, the mass of the first support 511v2 is increased. Thus, similar to the exemplary structure 1, a desirable stress resistance of the sensor element 30 can be ensured and the sensor element 30 can be stably held similar to the exemplary structure 2.

### Exemplary Structure 6

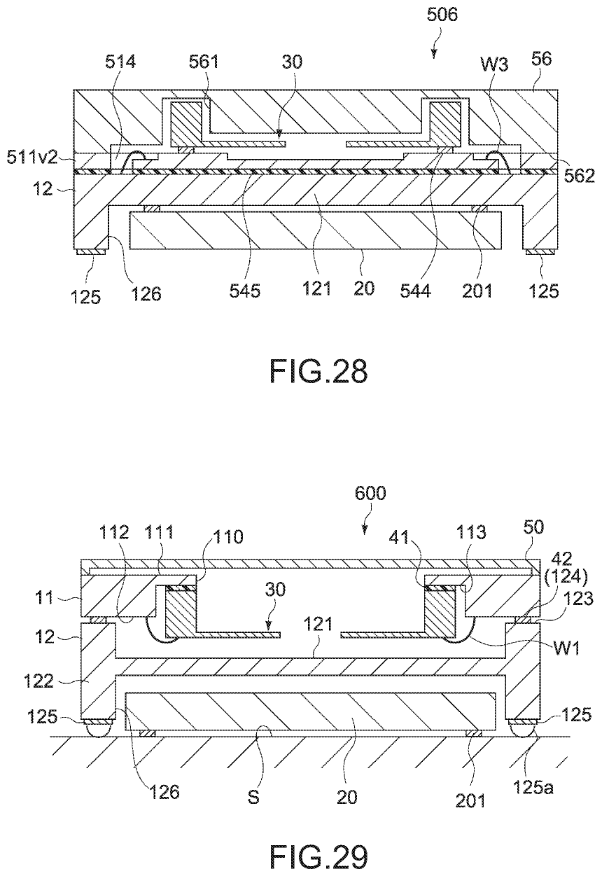

FIG. 28 is a schematic sectional side view showing other exemplary structure according to the present embodiment. In a sensor device 506 of the present embodiment, a structure of a cap 56 is different from that of the above-described exemplary structure 5.

In the sensor device 506 of this exemplary structure, the cap 56 is formed of a metal plate thicker than the first support 511v2 and the whole of the cap 56 is used as the weight member. The cap 56 is typically formed of the metal plate. At an inner surface side facing to the first support 511v2, a rectangular concave groove 561 that avoids a contact with the sensor element 30 and a leg 562 bonded to an upper surface periphery of the first support 511v2 are arranged.

In this exemplary structure, the functions and effects similar to those of the above-described exemplary structure 5 can be provided and the cap 56 functions as a weight member. Thus, the first support 511v2 is more stably supported on the second support 12, to thereby more stably holding the oscillation mode of the sensor element 30.

While the embodiments of the present technology are described, it should be appreciated that the present technology is not limited thereto and various modifications may be made.

For example, in the above-described embodiments, the multiaxial angular velocity sensor elements shown in FIG. 5 to FIG. 9 are illustrated and described as the sensor element 30, but is not limited there, and a uniaxial angular velocity sensor element may be used. In addition, the sensor element 30 is not limited to the angular velocity sensor element and may be a sensor element capable of detecting other physical quantity such as acceleration, a pressure, and a temperature. Also, an image sensor capable of capturing an image corresponding to incident light flux or the like may be applicable.

Furthermore, while the sensor device having the space 126 that encloses the controller 20 is described in the above-described first, second, and fifth embodiments, it may have a structure that the controller 20 mounted to a mounting area of the circuit substrate S can be enclosed in the space 126 like a sensor device 600 shown in FIG. 29. Thus, it can be possible to simplify the structure of the sensor device, improve a mounting density, or the like. Note that the electronic component enclosed in the space 126 is not limited to the controller 20 and may be passive components such as a capacitor or other sensor components.

Note that the present technology may also have the following structures.

(1) A sensor device, including:

a sensor element detecting input physical quantity;

a package body including a first support being electrically connected to the sensor element and supporting the sensor element and a second support being electrically connected to the first support and supporting the first support;

a first buffer being arranged between the sensor element and the first support and elastically connecting the sensor element to the first support; and

a second buffer being arranged between the first support and the second support and elastically connecting the first support to the second support.

(2) The sensor device according to (1), in which

the first buffer is formed of a material having an elastic modulus smaller than that of the second buffer.

(3) The sensor device according to (1), in which

the first buffer is formed of a material having an elastic modulus greater than that of the second buffer.

(4) The sensor device according to any one of (1) to (3), in which

the second support has a support surface supporting the first support via the second buffer, a horizontal wall in parallel with the support surface, and a vertical wall perpendicular to the horizontal wall.

(5) The sensor device according to (4), in which

the vertical wall is a peripheral wall arranged along a periphery of the horizontal wall.

(6) The sensor device according to (4) or (5), in which

the support surface is arranged at one end of the vertical wall, and

the second support further has an external connection terminal arranged at another end of the vertical wall.

(7) The sensor device according to (5) or (6), further including:

a circuit element enclosed in a space partitioned by the horizontal wall and the vertical wall.

(8) The sensor device according to (6) or (7), further including:

a third support supporting the second support; and

a third buffer being arranged between the second support and the third support and elastically connecting the second support to the third support.

(9) The sensor device according to any one of (1) to (8), in which

the first and second buffers are formed of any one of an adhesive resin layer, a metal bump, or an anisotropic conductive film.

(10) The sensor device according to any one of (1) to (9), in which

the first and second supports are formed of any of ceramics or silicon.

(11) The sensor device according to any one of (1) to (10), further including:

a cap being attached to the package body and covering the sensor element.

(12) The sensor device according to (11), in which

the cap is attached to the first support.

(13) The sensor device according to (11), in which

the cap is attached to the second support.

(14) The sensor device according to (12), in which

the first support has an opening, and

the cap has a weight protruding toward the sensor element via the opening.

(15) The sensor device according to (13), in which

the first support is enclosed inside the second support.

(16) The sensor device according to any one of (1) to (15), in which

the sensor element detects at least one of an angular velocity, acceleration, or a pressure.

(17) An electronic apparatus, including:

a sensor device; including

a sensor element detecting input physical quantity,

a package body including a first support being electrically connected to the sensor element and supporting the sensor element and a second support being electrically connected to the first support and supporting the first support,

a first buffer being arranged between the sensor element and the first support and elastically connecting the sensor element to the first support, and

a second buffer being arranged between the first support and the second support and elastically connecting the first support to the second support.

### REFERENCE SIGNS LIST

10A to 10E package body

11, 13, 16, 511 first support

12, 14, 17 second support

15 third support

20 controller

30 sensor element

41, 44, 541, 544 first buffer

42, 45, 542, 545 second buffer

43 third buffer

50, 51, 52, 54, 55, 56 cap

100, 200, 300, 400, 500 sensor device

121, 141 horizontal wall

122, 142 vertical wall

123, 143 support surface

126 space

552 weight member

1. A sensor device, comprising:
a sensor element detecting input physical quantity;
a package body including a first support being electrically connected to the sensor element and supporting the sensor element and a second support being electrically connected to the first support and supporting the first support;
a first buffer being arranged between the sensor element and the first support and elastically connecting the sensor element to the first support; and
a second buffer being arranged between the first support and the second support and elastically connecting the first support to the second support.

2. The sensor device according to claim 1, wherein
the first buffer is formed of a material having an elastic modulus smaller than that of the second buffer.

3. The sensor device according to claim 1, wherein
the first buffer is formed of a material having an elastic modulus greater than that of the second buffer.

4. The sensor device according to claim 1, wherein
the second support has a support surface supporting the first support via the second buffer, a horizontal wall in parallel with the support surface, and a vertical wall perpendicular to the horizontal wall.

5. The sensor device according to claim 4, wherein
the vertical wall is a peripheral wall arranged along a periphery of the horizontal wall.

6. The sensor device according to claim 4, wherein
the support surface is arranged at one end of the vertical wall, and
the second support further has an external connection terminal arranged at another end of the vertical wall.

7. The sensor device according to claim 5, further comprising:
a circuit element enclosed in a space partitioned by the horizontal wall and the vertical wall.

8. The sensor device according to claim 6, further comprising:
a third support supporting the second support; and
a third buffer being arranged between the second support and the third support and elastically connecting the second support to the third support.

9. The sensor device according to claim 1, wherein
the first and second buffers are formed of any one of an adhesive resin layer, a metal bump, or an anisotropic conductive film.

10. The sensor device according to claim 1, wherein
the first and second supports are formed of any of ceramics or silicon.

11. The sensor device according to claim 1, further comprising:
a cap being attached to the package body and covering the sensor element.

12. The sensor device according to claim 11, wherein
the cap is attached to the first support.

13. The sensor device according to claim 11, wherein
the cap is attached to the second support.

14. The sensor device according to claim 12, wherein
the first support has an opening, and
the cap has a weight protruding toward the sensor element via the opening.

15. The sensor device according to claim 13, wherein
the first support is enclosed inside the second support.

16. The sensor device according to claim 1, wherein
the sensor element detects at least one of an angular velocity, acceleration, or a pressure.

17. An electronic apparatus, comprising:
a sensor device; including
a sensor element detecting input physical quantity,
a package body including a first support being electrically connected to the sensor element and supporting the sensor element and a second support being electrically connected to the first support and supporting the first support,
a first buffer being arranged between the sensor element and the first support and elastically connecting the sensor element to the first support, and
a second buffer being arranged between the first support and the second support and elastically connecting the first support to the second support.
